(19) United States
(12) Patent Application Publication
(10) Pub. No.: US 2011/0260698 A1
(43) Pub. Date: Oct. 27, 2011

(54) GENERATOR UNIT FOR A MOTOR VEHICLE ELECTRICAL SYSTEM

(76) Inventors: Thomas Peuser, Ludwigsburg (DE); Markus Beck, Steinheim (DE); Roman Lahmeyer, Benningen (DE)

(21) Appl. No.: 13/126,312

(22) PCT Filed: Nov. 3, 2009
(86) PCT No.: PCT/EP2009/064484

§ 371 Date: Jun. 27, 2011

(30) Foreign Application Priority Data
Nov. 6, 2008 (DE) 10 2008 043 509.0

(51) Int. Cl. H02P 9/00

(52) U.S. Cl. 322/59

(57) ABSTRACT

A generator unit for a motor vehicle electrical system includes a generator, a first regulator module for regulating the operation of the generator and a digital interface, which is combined with the first regulator module to form one assembly, and includes a program-controlled second regulator module, which is also integrated into the assembly and receives control information via the digital interface.

### FIELD OF THE INVENTION

The present invention relates to a generator unit for the power supply of a vehicle electrical system in a motor vehicle.

### BACKGROUND INFORMATION

German Patent No. DE 103 21 872 describes a generator unit for a motor vehicle electrical system in which two regulator modules cooperate to regulate the operation of a generator. A first of these regulator modules is combined with the generator in a generator unit and receives control information from the structurally separate second generator module via a digital interface. The second regulator module is implemented by software in a control unit. During normal operation, the second regulator module triggers a switching transistor to adjust the field current of the generator. If the manipulated variable output by the second regulator module is not plausible because its value or its rate of change is outside of an allowed range and this indicates a disturbance in the second regulator module, for example, the first regulator module takes over the regulation of the generator.

The implementation of the second regulator module in software form allows the implementation of complex regulation strategies which have been optimized from various standpoints. However, one problem with this known generator unit is ensuring trouble-free communication between the generator unit and the external second regulator module. If adaptations or further developments are implemented in the generator unit, it is usually necessary for these to be taken into account in the software of the second regulator module to ensure smooth cooperation. If the second regulator module is integrated into an engine control unit in a manner which is economically reasonable per se, and if the engine control unit and generator unit of a vehicle are supplied by different manufacturers, they must be coordinated in each further development. This makes further development cumbersome and expensive.

### SUMMARY OF THE INVENTION

The subject matter of the present invention is a generator unit for a motor vehicle electrical system having a generator, a first regulator module for regulating the operation of a generator and a digital interface which is combined with the first regulator module in one assembly and having a program-controlled second regulator module, the second regulator module being integrated into the assembly and receiving control information via the digital interface. Such a generator unit is flexibly adaptable to various use environments without necessitating complex adaptations outside of the generator unit because all changes which may be made in the generator or the first regulator module, if necessary to adapt the generator unit to a certain type of vehicle, for example, may be taken into account in the programming of the second regulator module in such a way that adaptations in external units, which supply control information via the digital interface, such as an engine control unit, may be omitted.

In the simplest case, the second regulator module may have only the function of a protocol converter which converts control information supplied by an external unit into a format processable by the first regulator module. However, the second regulator module is preferably set up to regulate the generator itself during a normal operating state while the first regulator module assumes the role of regulating the generator only during a disturbed operating state. This allows implementation of complex regulation strategies in the second regulator module, whereas the functionalities of the first regulator module may be limited to the elementary functions absolutely essential for the power supply to the vehicle electrical system, and the first regulator module may be constructed to be simple and robust accordingly.

The second regulator module is preferably designed to perform the regulation of the generator at least partially on the basis of original measured values of sensors. This eliminates the necessity of processing these measured values for the generator control in the case of an external source of control information such as an engine control unit. This simplifies the operating software of the engine control unit. if the engine control unit supplies control information for the generator, this may be done in a form which is independent of the type of generator. Consequently, it is not necessary to have different versions of the operating software of the control unit for each type of generator.

During a disturbed operating state, the generator is preferably regulated without access to the control information received via the digital interface. The regulation by the first regulator module cannot be optimal then but there is no risk that the first regulator module will regulate in a completely unsuitable manner because of erroneous or missing control information.

A control module may make decisions about the existence of the normal operating state or the disturbed operating state on the basis of the value of at least one operating state variable of the vehicle electrical system.

If the control module is set up to make the decision about the existence of the normal operating state or the disturbed operating state as a function of whether or not a limiting value of the operating state parameter has been exceeded, then the limiting value may be settable by the second regulator module. An adaptation of the control module to an application environment in which the generator unit is used is therefore not necessary prior to installation of the unit; this is performed automatically by the second regulator module. The measures necessary to do so are easily implementable in the second regulator module in the form of programming steps.

To prevent malfunctions, the possibility of setting the limiting value may be limited to the time during which the generator unit is in normal operating mode.

Due to the fact that first regulator model is implemented as an ASIC, it is suitable in particular for carrying out standard regulator functions, which are not subject to any changes depending on the particular application environment. The first regulator module may thus be used as a uniform standard module in generator units according to the present invention in combination with the second regulator module for many different types of vehicles, which is advantageous with regard to the components to be kept on hand.

When the first regulator module is combined with the control module in a semiconductor module in particular, this yields additional advantages with regard to the space required for the generator unit and with regard to the number of components used.

### BRIEF DESCRIPTION OF THE DRAWING

FIG. 1 shows a schematic diagram of a detail of a vehicle electrical system for a motor vehicle having a generator unit according to the present invention.

### DETAILED DESCRIPTION

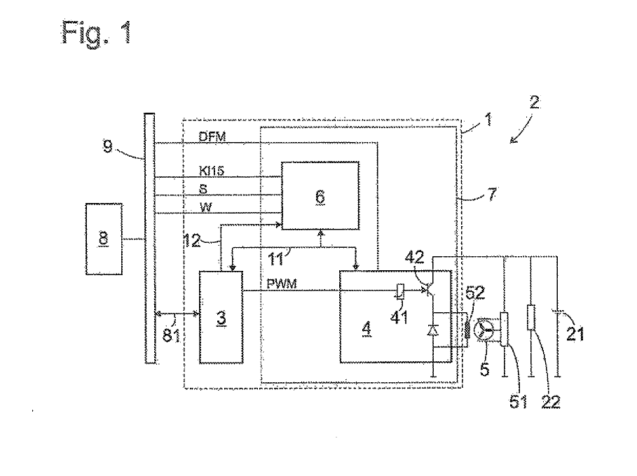

FIG. 1 schematically shows a detail of a vehicle electrical system 2 for a motor vehicle. Vehicle electrical system 2 includes a generator regulator 1, which causes a generator 5 to generate an output voltage via the output of a manipulated variable, this output voltage being supplied to vehicle electrical system 2 via a rectifier 51 connected to generator 5. Vehicle electrical system 2 also includes a battery 21 and a plurality of electric consumers 22. Generator regulator 1 is connected to a control unit 8 of the vehicle electrical system via a plug 9 and a digital bus, plug 9 including connecting lines of a digital interface 81 and analog connecting lines DFM (generator utilization), KI15 (terminal 15, power controller on), S (sense, battery terminal voltage) and W (generator phase).

Generator regulator 1 includes an elementary regulator module 4, which is implemented in an ASIC, a higher-level regulator module 3, which is implemented as a programmable digital circuit, in particular as a microcontroller, FPGA or CPLD module, and a control module 6. In a preferred embodiment of the present invention, elementary regulator module 4 and control module 6 are combined in a shared semiconductor module 7.

Elementary regulator module 4 includes an output stage, which is triggerable by a PWM control signal and outputs a field current, which is proportional to the duty cycle of the PWM control signal, to a field coil 52 of generator 5. A reversing switch 41 is connected upstream from the control input of output stage 42, making it possible to obtain the PWM control signal optionally from an internal regulating circuit of elementary regulator module 4 or from higher-level regulator module 3.

The internal regulating circuit derives the PWM control signal according to a hard-wired relationship from the terminal voltage of the battery or an output voltage of generator 5 and, if necessary, from other control parameters such as signals KI15, W, an operating temperature of generator 5 detected by a sensor, etc.

Elementary regulator module 4 may obtain the control parameters via plug 9 and the digital bus. For this purpose, elementary regulator module 4 and control module 6 use a shared bus interface in the embodiment shown FIG. 1. Control parameters measured on the generator may also be supplied to elementary regulator module 4 over direct lines, in particular as analog signals, to rule out the possibility that the control parameters might not reach elementary regulator module 4 because of interference on the bus.

Control module 6 receives signals KI15, S and W via plug 9. To determine whether there is a disturbance in the power supply of the vehicle electrical system, control unit 6 compares, for example, the level of S or the speed of a change in this level with a limiting value specified previously by higher-level control module 3. A disturbance in the power supply is detected when the level of S is outside of an interval between two such limiting values or when the rate of change exceeds a limiting value. As long as there is no disturbance, control module 6 controls reversing switch 41 to apply the PWM signal of higher-level control module 3 to output stage 42. In the event of a disturbance, the PWM signal of the regulating circuit of elementary regulator module 4 is connected through to output stage 42. If the vehicle electrical system voltage is outside of the allowed interval, a correction must take place as rapidly as possible to minimize the risk of damage or data loss for consumers connected to the vehicle electrical system. Elementary regulator module 4 is more suitable for such a rapid correction than program-controlled higher-level regulator module 3 because of the faster response times of the ASIC module.

Furthermore, control module 6 is connected to higher-level regulator module 3 via a signal line 12. Higher-level regulator module 3 is programmed to output a manipulated variable to generator 5 during normal operation at fixed time intervals, normally every 100 ms, and to display this activity by output of a dead man's signal on signal line 12. The output of the manipulated variable may lie, for example, in updating the duty cycle of the PWM signal. The dead man's signal may be, for example, a reversal of the level of a voltage on signal line 12, which occurs after each output of the manipulated variable, or it may be a pulse output after each manipulated variable output. If the dead man's signal fails to occur, this indicates a disturbance in the program sequence in higher-level regulator module 3. Since in such a case it cannot be assumed that the manipulated variable output to generator 5 is correct, control module 6 operates reversing switch 41, so that generator 5 is triggered by elementary control module 4.

A signal of the control module with which this triggers reversing switch 41 is also supplied to higher-level regulator module 3. Higher-level regulator module 3 is thus able to recognize when the generator unit is running in disturbance mode and generator 5 is not responding to the output manipulated variable. In this case, tracking of internal regulator circuits of higher-level regulator module 3 is stopped to prevent stored parameters of higher-level regulator module 3 from being adjusted in the futile attempt to influence generator 5 to values which, when control unit 6 later returns to normal operation, would result in completely unsuitable output values of the manipulated variable.

A return to normal operation occurs when the signal levels monitored by the control unit are again in the allowed range.

The function of higher-level regulator module 3 may be limited to converting control commands for generator 5, which are coded in any form, received via the bus and directly represent a desired generator power, into a PWM signal of a form adapted for generator 5 and output stage 41, so that an external control unit such as an on-board computer which supplies these control commands no longer needs any adaptation to the components of the generator unit. These adaptations may be performed easily on the part of higher-level regulator module 3 by adapting its software.

Higher-level regulator module 3 also preferably performs tasks still associated with the specification of the desired generator power. This may relieve the burden on the external control unit. Its operating software becomes simpler and, since it is largely independent of the technical details of the generator unit, it is needed only in a small number of different versions and the response times of the external control unit in the control tasks remaining to it may be shortened. To perform the calculations required for specifying the manipulated variable for generator 5, higher-level regulator module 3 receives measured values from sensors directly or via the bus, such as measured values of the battery terminal voltage and/or the generator temperature. Thus the information received by the higher-level regulator module from the on-board computer may be limited, for example, to information about the consumers in use or their total power consumption. Triggering of the generator, which may satisfy the power demand in the long run and fulfills boundary conditions such as preventing an excessively high operating temperature of the generator, is established by higher-level regulator module 3 on the basis of this specification without having to claim computation power of the onboard computer.

When speaking of normal and disturbed operating modes above, this is not to be understood to mean that any switching to the disturbed operating mode is associated with a technical disturbance requiring correction. Brief phases in the disturbed operating mode may also occur when the generator unit is completely intact, in particular because of short-term fluctuations in the power of the connected consumers. Only if the disturbed operating mode persists over a predefined maximum period of time or occurs repeatedly does the driver receive a message indicating the disturbance and the need for elimination thereof as well as, if necessary, a reference to the limiting value which, when exceeded, results in the identification of the disturbance by control module 6.

1-8. (canceled)

9. A generator unit for a motor vehicle electrical system, comprising:
a generator;
a first regulator module for regulating an operation of the generator;
a digital interface combined with the first regulator module in one assembly; and
a program-controlled second regulator module, the second regulator module being integrated into the assembly and receiving control information via the digital interface.

10. The generator unit according to claim 9, wherein the second regulator module is equipped to regulate the generator during a normal operating state, and the first regulator module is equipped to regulate the generator during a disturbed operating state.

11. The generator unit according to claim 10, wherein the control information received via the digital interface includes at least in part original measured values by sensors.

12. The generator unit according to claim 10, wherein the regulation during the disturbed operating state is performed without access to control information received via the digital interface.

13. The generator unit according to claims 10, further comprising a control module for determining an existence of the normal operating state or the disturbed operating state on the basis of a value of at least one operating state variable of the vehicle electrical system.

14. The generator unit according to claim 13, wherein the control module is equipped to make a decision about the existence of the normal operating state or the disturbed operating state as a function of whether or not a limiting value of the operating state variable is exceeded, and the limiting value is settable by the second regulator module.

15. The generator unit according to claim 9, wherein the first regulator module is implemented as an ASIC.

16. The generator unit according to claim 9, wherein the first regulator module is combined with a control module in a semiconductor module.
